(19) United States
(12) Patent Application Publication
(10) Pub. No.: US 2010/0150384 A1
(43) Pub. Date: Jun. 17, 2010

(54) PROVIDING HEARING HEALTH CARE SERVICES BY MEANS OF A HOME ENTERTAINMENT DEVICE

(75) Inventor: Bernd Waldmann, Maur (CH)

Correspondence Address: PEARNE & GORDON LLP, 1801 EAST 9TH STREET, SUITE 1200, CLEVELAND, OH, 44114-3108, US

(73) Assignee: PHONAK AG, Staefa (CH)

(21) Appl. No.: 12/517,934

(22) PCT Filed: Dec. 13, 2006
(86) PCT No.: PCT/EP06/69649

§ 371 Date: Oct. 29, 2009

(51) Int. Cl. H04R 25/00; G06Q 40/00

(52) U.S. Cl. 381/312; 705/39

(57) ABSTRACT

The invention suggests to use a home entertainment system (1, 2, 3, 4a, 4b) for providing hearing health care services. The system for providing hearing health care services comprises a home entertainment system comprising at least one processor (10), wherein said home entertainment system is adapted to let a hearing health care software run on said at least one processor. The method for providing hearing health care services comprises the step of letting a hearing health care software run on a processor (10) of a home entertainment system (1, 2, 3, 4a, 4b). Preferably, said home entertainment system comprises at least one of a set-top box (1) for digital television; a media center for presentation of digitally stored audio content, video content and/or photo content; a media center for presentation of digitally streaming audio and/or video content; a game console; a television set (3). Said hearing health care software preferably allows for at least one of hearing testing; training for hearing with a hearing device; simulation of hearing device function as a demonstration of hearing device benefit; adjustment of hearing device parameters according to the preferences of a user of said hearing device; upgrades or modifications to hearing device operating software and/or hearing device operating parameters.

### TECHNICAL FIELD

The invention relates to the field of hearing health care. More particularly, the invention relates to a system and a method for providing hearing health care services and to a use of a home entertainment system for providing hearing health care services.

### DEFINITIONS

Under hearing health care services, we understand services related to the diagnosis, therapy or rehabilitation of a hearing impaired person, including the provision of means and methods that reduce the disability and handicap caused by the impairment. Examples are hearing tests, hearing training, simulation of hearing aid benefit.

Under a hearing device, a device is understood, which is worn in or adjacent to an individual's ear with the object to improve the individual's acoustical perception. Such improvement may also be barring acoustic signals from being perceived in the sense of hearing protection for the individual. If the hearing device is tailored so as to improve the perception of a hearing impaired individual towards hearing perception of a “standard” individual, then we speak of a hearing-aid device. With respect to the application area, a hearing device may be applied behind the ear, in the ear, completely in the ear canal or may be implanted.

### BACKGROUND OF THE INVENTION

Today, most steps in hearing health care, in particular hearing testing and fitting of a hearing device, take place in an audiologist's office.

In U.S. Pat. No. 6,322,521 B1a method and a system for on-line hearing examination and correction is disclosed, wherein the system comprises a local personal computer comprising a sound card and speakers, which personal computer is connected—via a data network—to a remote hearing assistant server.

In US 2002/0054689 A1, a method and a system for remotely upgrading a hearing aid device is disclosed, wherein a connection via a public network is used to access a remote hearing aid upgrade server.

In WO 2005/125002 A2, a system and a method for diagnosing hearing loss in an individual is disclosed. The system comprises a CD or videotape containing test sounds (tones at different frequencies) and verbal instructions. Guided by the verbal instructions, the individual selects tracks on the CD/videotape with tones at different frequencies and listens to these. A personal computer is used as a communication means for accessing a Web site for a more thorough hearing test.

In U.S. Pat. No. 6,447,461 B1, a method and system for conducting a hearing test using a computer and headphones is disclosed.

In WO 2005/125278 A2, an at-home hearing aid training system and method is disclosed, in which a computer is used for running hearing test programs.

Personal computers are today widely available and used, but the at-home availability of personal computers among elderly and less affluent people is reduced with respect to that of young and affluent people. On the other hand, the elderly make up the major portion of hearing device users.

It is therefore desirable to provide for alternative ways of providing hearing health care services.

### SUMMARY OF THE INVENTION

One object of the invention is to create alternative ways of providing hearing health care services. A system for providing hearing health care services and a method for providing hearing health care services shall be created, which do not have the disadvantages mentioned above. In addition, a use of a home entertainment system for providing hearing health care services shall be provided.

Another object of the invention is to provide for an increased convenience for a person to whom hearing health care services are provided, in particular if the person provides itself with the hearing health care services.

The system for providing hearing health care services comprises
a home entertainment system comprising at least one processor,
   wherein said home entertainment system is adapted to let a hearing health care software run on said at least one processor.

The method for providing hearing health care services comprises the step of letting a hearing health care software run on a processor of a home entertainment system.

The invention furthermore comprises the use of a home entertainment system for providing hearing health care services.

This allows to provide a wide range of hearing device users with hearing health care services, in particular users, which do not have a personal computer at home or which have a personal computer only in an office, but prefer to receive hearing health care services in their living room, in which they have a home entertainment system.

Today, home entertainment systems are widely used in private households, and their processing capability is rather large. This processing power can—according to the invention—be used for running hearing health care software.

Home entertainment systems are usually specialized in performing only one or only a very limited number of specific tasks. Their user interface is usually adapted to this limited number of tasks and typically comprises—for receiving input from a user—only up to 5 or up to 10 buttons or knobs. In most home entertainment systems, there is no possibility provided for a user to install additional software. In some home entertainment systems, it may be possible to update the home entertainment system's firmware, but this is not an installation of additional software, since an old version of the firmware is replaced by a new version of the firmware. The user interface of most home entertainment systems is easy to handle, and a user of the home entertainment system knows this user interface well and is familiar to using it, which eases—for said user—the use of the home entertainment system as a hearing health care services providing system.

In one embodiment, said home entertainment system comprises a storage unit in which data defining said hearing health care software are stored.

In one embodiment, said hearing health care software is running on said processor.

In one embodiment, said hearing health care software, when running on said processor, allows for at least one of the group comprising
hearing testing;
training for hearing with a hearing device;
training for hearing without a hearing device;
simulation of hearing device function as a demonstration of hearing device benefit;
adjustment of hearing device parameters according to the preferences of a user of said hearing device;
electronic payment for services associated with hearing health care;
electronic payment for services associated with the use of a hearing device;
upgrades or modifications to hearing device operating software and/or hearing device operating parameters;
exchange of hearing device operating parameters between a hearing device and a central database;
exchange of hearing device operating parameters between hearing devices of different hearing device users.

In case of said exchange of hearing device operating parameters between a hearing device and a central database, said hearing device operating parameters comprise data logging data. Data logging data are described in detail in EP 1 414 271 A2.

In one embodiment, said home entertainment system comprises at least one of the group comprising
a set-top box for digital television;
a media center for presentation of digitally stored audio content, video content and/or photo content;
a media center for presentation of digitally streaming audio and/or video content;
a game console;
a television set.

In particular: In one embodiment, said home entertainment system comprises a set-top box for digital television. In one embodiment, said home entertainment system comprises a media center for presentation of digitally stored audio content, video content and/or photo content. In one embodiment, said home entertainment system comprises a media center for presentation of digitally streaming audio and/or video content. In one embodiment, said home entertainment system comprises a television set. In one embodiment, said home entertainment system comprises a game console.

These are examples for home entertainment systems. In particular, said home entertainment system is exactly one of the group described above.

In one embodiment, said home entertainment system comprises a sound unit, which comprises at least one of
a sound-generation unit;
a sound-data storage unit;
a sound reproduction unit.

Preferably, it comprises all three.

In one embodiment, said home entertainment system comprises a connecting unit for establishing a connection to the internet.

In one embodiment, said system is free from interfaces for operationally connecting a full keyboard to the system. A “full keyboard” refers to those input units, which are commonly used for personal computers. Such full keyboards usually comprise at least 30, rather more than 50 and even more than 60 keys (buttons), mainly for entering alphanumeric information. In this embodiment, the system according to the invention has no provision for operationally connecting to such a full keyboard.

In one embodiment, the system is free from interfaces which would allow a user of the system to install additional software in the system. Personal computers are designed such that a user of the personal computer can install additional software in the personal computer, whereas such a feature is typically not foreseen in home entertainment systems. The above-mentioned hearing health care software will usually not be installed by a user of the home entertainment system, but, e.g., by the manufacturer of the home entertainment system.

Further embodiments of methods according to the invention and of uses according to the invention can be derived from corresponding systems according to the invention.

Further objects emerge from the description and embodiments below.

At least one of these objects is at least partially achieved by systems and methods according to the patent claims.

The advantages of the methods and uses correspond to the advantages of corresponding systems.

Further preferred embodiments and advantages emerge from the dependent claims and the FIGURES.

### BRIEF DESCRIPTION OF THE DRAWINGS

Below, the invention is described in more detail by means of examples and the included drawing. The FIGURE shows schematically:

FIG. 1 an illustration of a system according to the invention.

The reference symbols used in the FIGURES and their meaning are summarized in the list of reference symbols. The described embodiments are meant as examples and shall not confine the invention.

### DETAILED DESCRIPTION OF THE INVENTION

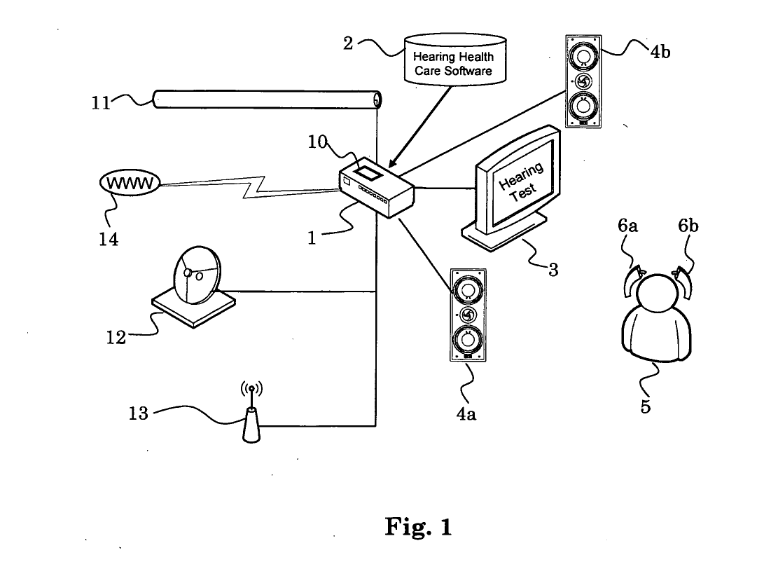

FIG. 1 shows an illustration of a system according to the invention. The system comprises a home entertainment system comprising a set-top box 1, a storage unit 2, a television set 3 and loudspeakers 4a,4b.

The set-top box 1 is operationally connected to at least one of the group comprising a digital TV cable 11, a satellite TV receiver 12, a digital TV antenna 13 and the internet 14 (WWW). The set-top box 1 receives digital TV signals from at least one of the digital TV sources 11,12,13,14, processes the digital TV signals and feeds the television set 3 and the loudspeakers 4a,4b with processed signals. In the conventional mode of operation, the home entertainment system is used by a user 5 for watching TV. A processor 10 of set-top box 1 is employed for said processing.

Said storage unit 2, e.g., a hard disk (preferably integrated in the set-top box 1) or a ROM or a flash memory device, comprises data defining a hearing health care software, which can be used, e.g., for hearing testing. In a mode of operation according to the invention, on said processor 10 of set-top box 1, said hearing health care software is run. The loudspeakers 4a,4b are used for generating test sounds (typically on the basis of electrical signals obtained from processor 10), and user 5, wearing hearing devices 6a,6b, can test his hearing by means of said hearing health care software. User controls such as knobs or buttons of the set-top box 1 or of a remote control of the set-top box (not shown) can be used for receiving input from the user, e.g., for indicating when a test sound is perceived, and on the television set 3, commands and results for user 5 can be displayed.

As becomes clear from the above, the invention suggests to use a home entertainment system for providing hearing health care services. User 5 might prefer using his home entertainment system for receiving hearing health care services over using a personal computer for this purpose, because he feels more comfortable handling his home entertainment system than handling a personal computer, and because his home entertainment system is installed in his living room, where he feels more comfortable than in an office, in which a personal computer might be installed.

List of Reference Symbols

| | |
|---|---|
| 1 | set-top box |
| 2 | storage unit |
| 3 | television set |
| 4a, 4b | loudspeaker |
| 5 | user |
| 6a, 6b | hearing device |
| 10 | processor |
| 11 | digital TV cable |
| 12 | satellite TV receiver |
| 13 | digital TV antenna |
| 14 | internet |

1. System for providing hearing health care services, comprising
a home entertainment system (1,2,3,4a,4b) comprising at least one processor (10),
wherein said home entertainment system (1,2,3,4a,4b) is adapted to let a hearing health care software run on said at least one processor.

2. The system according to claim 1, wherein said home entertainment system (1,2,3,4a,4b) comprises a storage unit (2) in which data defining said hearing health care software are stored.

3. The system according to claim 1 or claim 2, wherein said hearing health care software is running on said processor (10).

4. The system according to one of the preceding claims, wherein said hearing health care software, when running on said processor, allows for at least one of the group comprising
hearing testing;
training for hearing with a hearing device (6a;6b);
training for hearing without a hearing device (6a;6b);
simulation of hearing device function as a demonstration of hearing device benefit;
adjustment of hearing device parameters according to the preferences of a user (5) of said hearing device (6a;6b);
electronic payment for services associated with hearing health care;
electronic payment for services associated with the use of a hearing device (6a;6b);
upgrades or modifications to hearing device operating software and/or hearing device operating parameters;
exchange of hearing device operating parameters between a hearing device (6a;6b) and a central database;
exchange of hearing device operating parameters between hearing devices of different hearing device users.

5. The system according to one of the preceding claims, wherein said home entertainment system (1,2,3,4a,4b) comprises at least one of the group comprising
a set-top box (1) for digital television;
a media center for presentation of digitally stored audio content, video content and/or photo content;
a media center for presentation of digitally streaming audio and/or video content;
a game console;
a television set (3).

6. The system according to one of the preceding claims, wherein said home entertainment system (1,2,3,4a,4b) comprises a sound unit, which comprises at least one of
a sound-generation unit;
a sound-data storage unit;
a sound reproduction unit (4).

7. The system according to one of the preceding claims, wherein said home entertainment system (1,2,3,4a,4b) comprises a connecting unit for establishing a connection to the internet.

8. The system according to one of the preceding claims, which is free from interfaces for operationally connecting a full keyboard to the system.

9. The system according to one of the preceding claims, which is free from interfaces which would allow a user of the system to install additional software in the system.

10. Method for providing hearing health care services, comprising the step of letting a hearing health care software run on a processor (10) of a home entertainment system (1,2,3,4a,4b).

11. The method according to claim 8, wherein said home entertainment system (1,2,3,4a,4b) is a home entertainment system (1,2,3,4a,4b) as described in one of claims 1 to 9.

12. The method according to claim 10 or claim 11, wherein said home entertainment system (1,2,3,4a,4b) comprises at least one of the group comprising
a set-top box (1) for digital television;
a media center for presentation of digitally stored audio content, video content and/or photo content;
a media center for presentation of digitally streaming audio and/or video content;
a game console;
a television set (3).

13. The method according to one of claims 10 to 12, wherein said home entertainment system (1,2,3,4a,4b) is free from interfaces which would allow a user of the system to install additional software in said home entertainment system (1,2,3,4a,4b).

14. Use of a home entertainment system (1,2,3,4a,4b) for providing hearing health care services.

15. The use according to claim 14, wherein said home entertainment system (1,2,3,4a,4b) comprises at least one of the group comprising
a set-top box (1) for digital television;
a media center for presentation of digitally stored audio content, video content and/or photo content;
a media center for presentation of digitally streaming audio and/or video content;
a game console;
a television set (3).

16. The use according to claim 14 or claim 15, wherein said home entertainment system (1,2,3,4a,4b) is free from interfaces which would allow a user of the system to install additional software in said home entertainment system (1,2,3,4a,4b).
